(19) United States
(12) Patent Application Publication
(10) Pub. No.: US 2026/0204849 A1
(43) Pub. Date: Jul. 16, 2026

(54) FIXING BRACKET FOR A PANEL CONNECTER AND CASING ASSEMBLY HAVING THE SAME

(71) Applicant: ACBEL POLYTECH INC., New Taipei City (TW)

(72) Inventors: Yueh-Feng LI, New Taipei City (TW); Cheng-Chia LIN, New Taipei City (TW); Nung-Chin KAO, New Taipei City (TW); Chia-Hung CHIEN, New Taipei City (TW)

(73) Assignee: ACBEL POLYTECH INC., New Taipei City (TW)

(21) Appl. No.: 19/432,626

(22) Filed: Dec. 24, 2025

(30) Foreign Application Priority Data
Dec. 27, 2024 (TW) 113151358

(51) Int. Cl. H01R 13/74

(52) U.S. Cl. CPC H01R 13/745

(57) ABSTRACT

A fixing bracket includes: a fixing portion mounted around the panel connector and abutting at least three surfaces of two end surfaces and two side surfaces of the panel connector; an upper connecting portion bent and extending from an end of the fixing portion and having an upper through hole; and a front connecting portion bent from another end of the fixing portion, extending a certain distance, and then extending away from the fixing portion. The front connecting portion has a front through hole. The panel connector is mounted through a mounting surface of the casing assembly and is fixed in place with the fixing portion of the fixing bracket. Thus, the panel connector is stably positioned on the mounting surface of the casing assembly. Wobbling, tilting, or misaligning is prevented when external force is subjected to the panel connector, and misaligned insertion can be avoided.

### BACKGROUND OF THE INVENTION

### 1. Field of the Invention

The present invention relates to a fixing bracket, especially to a fixing bracket for a panel connector and a casing assembly having the same.

### 2. Description of the Prior Art(s)

Conventional panel connectors, especially to micro-Fit connectors, can be broadly categorized into two type by their fixing methods. One of the fixing methods is to directly fix the panel connector to a rigid print circuit board and then mount the panel connector to a mounting panel of a casing. In this integrated fixing method, in addition to that the connector has snap-fit fasteners oppositely disposed on top and bottom and abutting in corresponding holes on the mounting panel, there is also the rigid printed circuit board at the back for support. Therefore, it has a large load-bearing capacity and is not prone to wobbling when plugging and unplugging.

On the other hand, since the other fixing method is limited by space of the casing and arrangement of the system, connection between the connector and the printed circuit board requires multiple wires. In other words, the connector is directly mounted on the mounting panel of the casing and the printed circuit board is fixed to another location inside the casing. The connector and the printed circuit board are connected to each other via the wires, representing a separate fixing method.

However, in the separate fixing method, the connector is fixed only with the snap-fit fasteners abutting in the corresponding holes of the mounting panel of the casing. Therefore, when a plug is plugged in and unplugged from the connector, the connector is prone to wobbling, tilting or misaligning due to force applied thereon. The tilt or the misalignment of the connector would prevent a user from properly plugging and unplugging the wires, resulting in misaligned insertion. Said misaligned insertion causes pins of the connector to bend, leading to abnormal contact resistance and abnormal temperature rise. Therefore, improvements are needed to address the aforementioned problems and shortcomings.

### SUMMARY OF THE INVENTION

In view of the shortcomings of the prior arts, the present invention provides a fixing bracket for a panel connector and a casing assembly having the same. With the fixing bracket being mounted in the casing assembly and abutting on the panel connector, the purpose of strengthening the fixation of the panel connector can be achieved.

To achieve the aforementioned objective, the technical means employed in the present invention is to design a fixing bracket for a panel connector configured to fixing the panel connector. The panel connector comprises a main body and two snap-fit fasteners. The main body has two end surfaces oppositely disposed on top and bottom and two sidewalls oppositely disposed on left and right. The two snap-fit fasteners are respectively disposed on the two end surfaces of the main body. The fixing bracket comprising:
a fixing portion configured to be mounted on the main body and abutting on at least three surfaces of the two end surfaces and the two sidewalls of the main body; the fixing portion having a fixing recess recessed laterally; a shape of the fixing recess corresponding to a shape of the main body and the fixing recess having two notches; and the two notches located at two opposite bends on a bottom of the fixing recess;
an upper connecting portion bending from an end of the fixing portion and extending, and an upper through hole formed through the upper connecting portion; and
a front connecting portion bending from another end of the fixing portion, extending for a distance and then extending in a direction away from the fixing portion; and a front through hole formed through the front connecting portion.

To achieve the aforementioned objective, the technical means employed in the present invention is to design a casing assembly comprising an upper surface, a side surface and a mounting surface. The mounting surface is connected with the top surface and the side surface. A top hole is defined on the top surface, and a mounting hole and a connecting port are defined on the mounting surface. The casing assembly includes the fixing bracket as described. The panel connector is mounted through and is fixed in the connecting port. The fixing bracket is mounted on the panel connector with a fastener being mounted through the top hole and the upper through hole, and another fastener being mounted through the mounting hole and the front through hole.

The present invention has the advantages as follows. With the fixing portion of the fixing bracket abutting on the main body of the panel connector, the panel connector is able to be stably positioned on the mounting surface of the casing assembly. The fixing bracket is able to provide addition support within limited space to enhance restraint on the panel connector. Accordingly, when the panel connector is subjected to external force, the panel connector does not wobble, tilt or misalign, thus avoiding problems such as misaligned insertion. In addition, with the upper connecting portion having the guiding slot and the casing assembly having the guiding element, during installation, a user is able to make the guiding slot align with the guiding element so as to slide the fixing bracket, which helps the user quickly locate the fixing bracket.

### BRIEF DESCRIPTION OF THE DRAWINGS

FIG. 1 is a perspective view of a fixing bracket in accordance with the present invention;

FIG. 2 is another perspective view of the fixing bracket in accordance with the present invention;

FIG. 3 is a side view of the fixing bracket in accordance with the present invention;

FIG. 4 is a perspective view of a panel connector and the fixing bracket being mounted on a casing assembly in accordance with the present invention;

FIG. 5 is a is an interior view of the panel connector and the fixing bracket being mounted on the casing assembly in accordance with the present invention;

FIG. 6 is a is a cross-sectional side view of the panel connector and the fixing bracket being mounted on the casing assembly in accordance with the present invention;

FIG. 7 is a is an interior rear view of the panel connector and the fixing bracket being mounted on the casing assembly in accordance with the present invention;

FIG. 8 is a schematic view of another embodiment in accordance with the present invention.

### DETAILED DESCRIPTION OF THE PREFERRED EMBODIMENTS

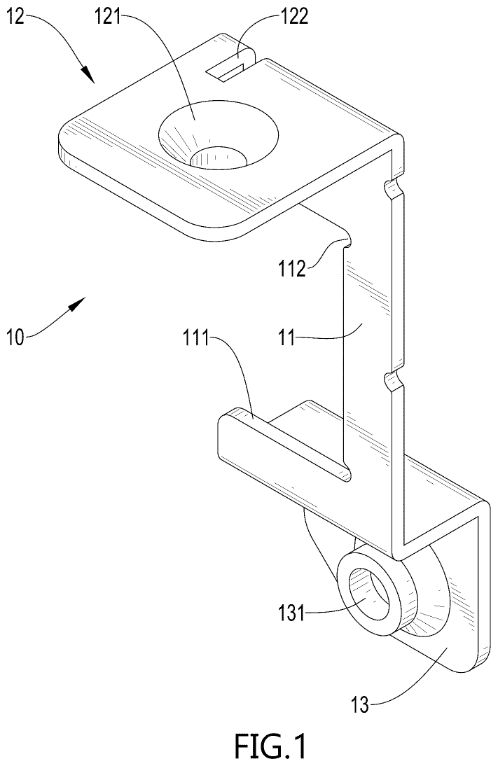

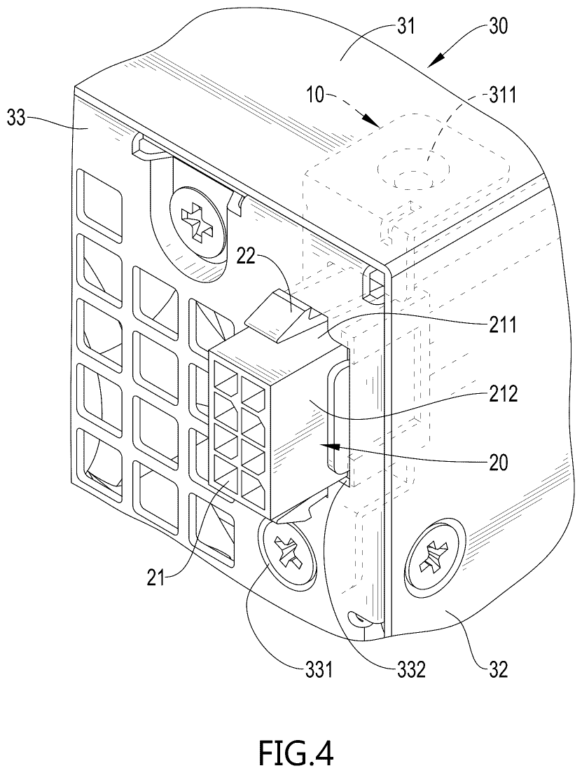

With reference to FIGS. 1 and 4, a fixing bracket for a panel connector in accordance with the present invention is shown. A specification of the panel connector 20 is illustrated with the Micro-Fit (3.0) as an example, but it is not limited thereto. Any rectangular connector used for installing on the panel is acceptable. The panel connector 20 comprises a main body 21 and two snap-fit fasteners 22. The main body 21 is rectangular in shape and has two end surfaces 211 oppositely disposed on top and bottom and two sidewalls 212 oppositely disposed on left and right. The two snap-fit fasteners 22 are respectively disposed on the opposite end surfaces 211 of the main body 21. The panel connector 20 is a conventional standard component and the detailed structure of the panel connector 20 will not be further described.

The fixing bracket 10 is an elongated sheet integrally formed as a single part and has a fixing portion 11, an upper connecting portion 12 and a front connecting portion 13.

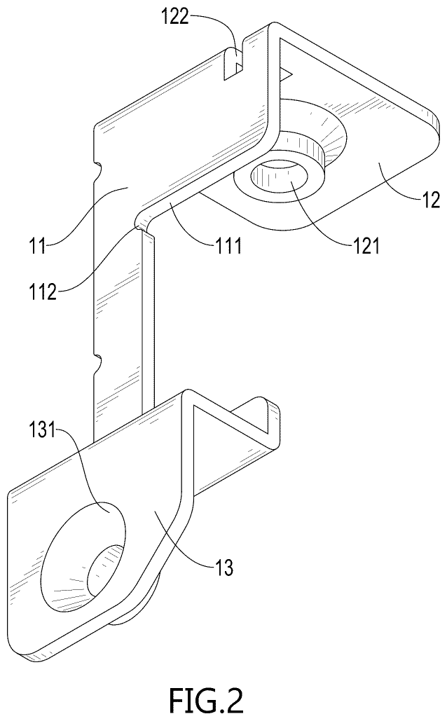

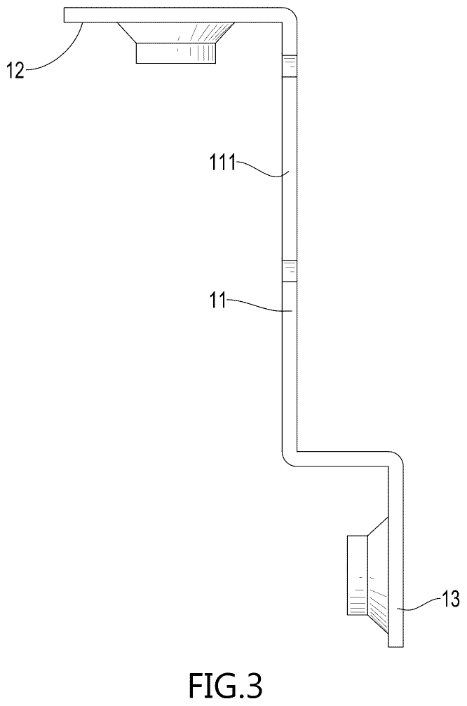

With reference to FIGS. 1 to 4, the fixing portion 11 has a fixing recess 111 recessed laterally. In this embodiment, the fixing recess 111 is a rectangular recess and a shape of the fixing recess 111 corresponds to a shape of the main body of the connector 20, specifically an outline of the end surfaces 211 and one of the sidewalls 212 of the main body 21. In this embodiment, the fixing recess 111 also has two notches 112. The two notches 112 are located at two opposite bends on a bottom of the fixing recess 111. However, it is not limited thereto, the notches 112 may be omitted. A form of the fixing portion 11 may be changed according to users'needs and has a structure with at least three surfaces of the two end surfaces 211 and the sidewalls 212 that are able to abut on the main body 21.

The upper connecting portion 12 bends at approximately 90 degrees from an end of the fixing portion 11 and extends. An upper through hole 121 is formed through the upper connecting portion 12. In this embodiment, a guiding slot 122 is formed. The guiding slot 122 extends from the fixing portion 11 toward the upper connecting portion 12 to form as an elongated slot. However, it is not limited thereto and the guiding slot 122 may be omitted.

The front connecting portion 13 bends toward the fixing portion 11 at approximately 90 degrees from another end of the fixing portion 11, extends for a distance and then extends in a direction away from the fixing portion 11. A front through hole 131 is formed through the front connecting portion 13. The front through hole 131 and the upper through hole 121 are two holes with their opening directions perpendicular to each other.

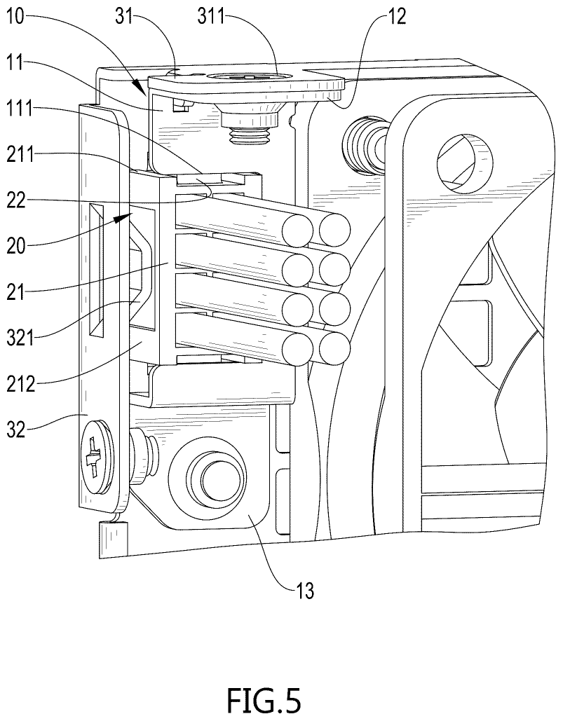

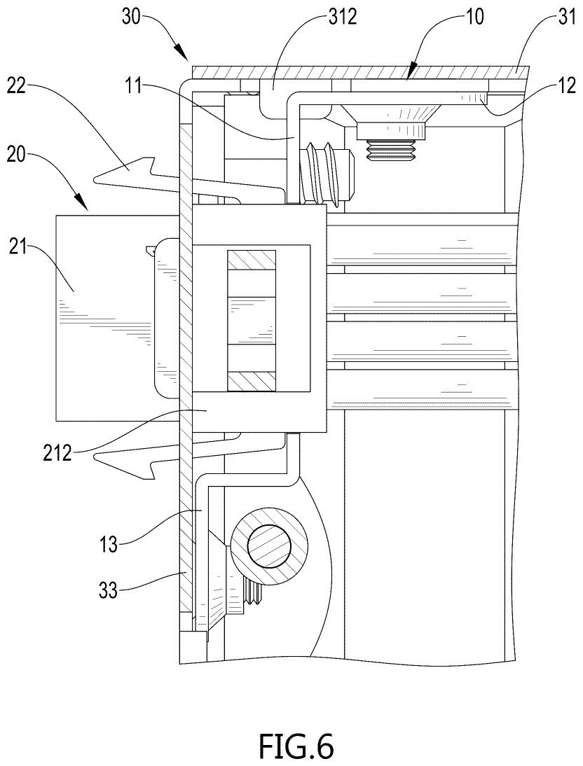

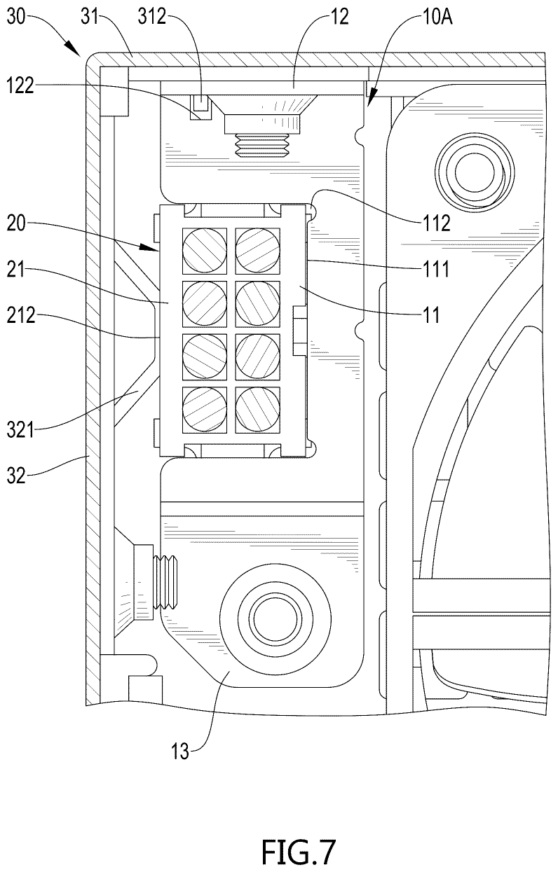

When the present invention is in use, with reference to FIGS. 4 to 7, take installing on a casing assembly 30 as an example. A size of the casing assembly 30 is standard 185 millimeter (mm)×62 mm×82 mm and has a top surface 31, a bottom surface, two side surfaces 32, a mounting surface 33 and a rear side surface. Since the bottom surface and the rear side surface are not the focus of the present invention, their structures will not be described in detail. Instead, the top surface 31, one of the side surfaces 32 and the mounting surface 33 of the casing assembly 30 will be used for explanation. The mounting surface 33 is connected with the top surface 31 and the side surface 32. A size of the mounting surface 33 is 62 mm×82 mm and is a type of the mounting surface 33 with smaller area. The mounting surface 33 of the casing assembly 30 further has multiple exhaust ports for a fan of a power supply (not shown in the drawings) to expel air. A mounting hole 331 and a connecting port 332 is defined between the exhaust ports and the side surface 32. The connecting port 332 is for installing the panel connector 20. Therefore, it can be concluded that space around the connecting port 322 is very limited. A top hole 311 and a guiding element 312 is defined on the top surface 31 of the casing assembly 30. The guiding element 312 protrudes downward. A protrusion 321 is formed on the side surface 32 of the casing assembly 30. The protrusion 321 protrudes toward the connecting port 332. The panel connector 20 is mounted through the connecting port 332 and is fixed with the two snap-fit fasteners 22. The protrusion 321 abuts on a neighboring one of the sidewalls 212 of the panel connector 20. However, it is not limited thereto, and the protrusion 321 may be omitted with the side surface 32 of the casing assembly 30 directly abutting thereon. Then a recess opening of the fixing recess 111 of the fixing bracket 10 faces toward the protrusion 321 and is mounted onto the panel connector 20 from a rear end of the panel connector 20. During the mounting process, the guiding element 312 slides along the guiding slot 122 and stops when the fixing portion 11 touches the two snap-fit fasteners 22. Thus, an inner edge of the fixing recess 111 abuts on the two end surfaces 211 and the other sidewall 212 of the panel connector 20. By using a fastener to be mounted through the top hole 311 and the upper through hole 121, an end of the fixing bracket 10 is secured to the top surface 31 of the casing assembly 30. By using another fastener to be mounted through the mounting hole 331 and the front through hole 131, another end of the fixing bracket 10 is secured to the mounting surface 33 of the casing assembly 30.

In the foregoing process, the two end surfaces 211 and one of the sidewalls 212 of the main body 21 of the installed panel connector 20 are abutted and fixed by the fixing portion 11 of the fixing bracket 10, the other sidewall 212 is abutted by the protrusion 321, and a rear end surface of the two snap-fit fasteners 22 of the panel connector 20 abuts on the fixing portion 11 of the fixing bracket 10 to limit it movement. Therefore, the panel connector 20 is able to be stably positioned on the mounting surface 33 of the casing assembly 30. Compared with the prior art, the fixing bracket 10 is able to provide addition support within the limited space to enhance restraint on the panel connector 20 in various directions. Accordingly, when a plug is plugged in (not shown in the drawings) and the panel connector 20 is subjected to external force, since the panel connector 20 is abutted and supported in five directions, the panel connector 20 does not wobble, tilt or misalign, thus avoiding problems such as misaligned insertion.

In the foregoing process, the fixing recess 111 is formed by having the two notches 112 and the notches 112 help the users to more easily and accurately fit the fixing bracket 10 onto the panel connector 20 during installation.

In the foregoing process, the upper connecting portion 12 is formed by having the guiding slot 122 and the casing assembly 30 is formed by having the guiding element 312. Thus, during installation, the user is able to make the guiding slot 122 align with the guiding element 312 so as to slide the fixing bracket 10, which helps the user quickly locate the fixing bracket 10.

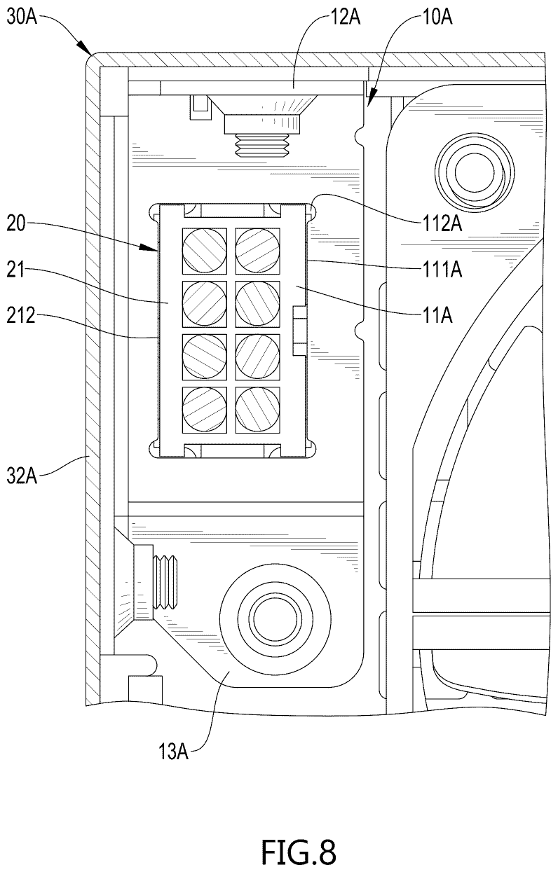

With reference to FIG. 8, another embodiment of the present invention is shown. The upper connecting portion 12A and the front connecting portion 13A of the fixing bracket 10A are all similar to the previous embodiment. This embodiment differs from the previous embodiment in that the fixing portion 11A does not have the fixing recess 111, a fixing port 111A is formed through the fixing portion 11A instead. A shape of the fixing port 111A corresponds to an outline of the main body 21 of the panel connector 20. Each of four corners of the fixing port 111A is also formed by having one notch 112A. The side surfaces 32A of the casing assembly 30A do not have the protrusion 321. Thus, during installation, the user is able to directly mount the fixing bracket 10A onto the main body 21 of the panel connector 20, so as to simultaneously fix the two end surfaces 211 and the two side surfaces 212 of the main body 21. With this fixing way, compared to the previous embodiment, a machining process for forming the protrusion 321 can be omitted, thus reducing cost.

1. A fixing bracket for a panel connector, configured to fix the panel connector; the panel connector comprising a main body and two snap-fit fasteners, the main body having two end surfaces oppositely disposed on top and bottom and two sidewalls oppositely disposed on left and right, and the two snap-fit fasteners respectively disposed on the two end surfaces of the main body; and the fixing bracket comprising:
a fixing portion configured to be mounted on the main body and abutting at least three surfaces of the two end surfaces and the two sidewalls of the main body; the fixing portion having a fixing recess recessed laterally; a shape of the fixing recess corresponding to a shape of the main body and the fixing recess having two notches; and the two notches located at two opposite bends on a bottom of the fixing recess;
an upper connecting portion bending from an end of the fixing portion and extending, and an upper through hole formed through the upper connecting portion; and
a front connecting portion bending from another end of the fixing portion, extending for a distance and then extending in a direction away from the fixing portion; and a front through hole formed through the front connecting portion.

2. The fixing bracket for a panel connector as claimed in claim 1, wherein: a fixing port is formed through the fixing portion; and a shape of the fixing port corresponds to an outline of the main body.

3. The fixing bracket for a panel connector as claimed in claim 2, wherein: the fixing port is formed by having four notches and the four notches are respectively formed in four corners of the fixing port.

4. The fixing bracket for a panel connector as claimed in claim 1, wherein: a specification of the panel connector is Micro-Fit.

5. The fixing bracket for a panel connector as claimed in claim 2, wherein: a specification of the panel connector is Micro-Fit.

6. The fixing bracket for a panel connector as claimed in claim 3, wherein: a specification of the panel connector is Micro-Fit.

7. The fixing bracket for a panel connector as claimed in claim 1, wherein: the upper connecting portion and the front connecting portion bend in reverse directions.

8. The fixing bracket for a panel connector as claimed in claim 2, wherein: the upper connecting portion and the front connecting portion bend in reverse directions.

9. The fixing bracket for a panel connector as claimed in claim 3, wherein: the upper connecting portion and the front connecting portion bend in reverse directions.

10. A casing assembly comprising an upper surface, a side surface and a mounting surface; the mounting surface connected with the top surface and the side surface; a top hole defined on the top surface, and a mounting hole and a connecting port defined on the mounting surface; the casing assembly includes the fixing bracket as claimed in claim 1; the panel connector mounted through and fixed in the connecting port; the fixing bracket mounted on the panel connector with a fastener being mounted through the top hole and the upper through hole, and another fastener being mounted through the mounting hole and the front through hole.

11. The casing assembly as claimed in claim 10, wherein: a guiding element protruding downward from the top surface of the casing assembly; a guiding slot is formed in the upper connecting portion; the guiding slot extends from the fixing portion 11 toward the upper connecting portion; and the guiding element is mounted in the guiding slot.

12. The casing assembly as claimed in claim 10, wherein: a protrusion is formed on the side surface of the casing assembly; and the protrusion protrudes toward the connecting port and abuts the panel connector.

13. The casing assembly as claimed in claim 11, wherein: a protrusion is formed on the side surface of the casing assembly; and the protrusion protrudes toward the connecting port and abuts the panel connector.
